(19) United States
(12) Patent Application Publication
(10) Pub. No.: US 2025/0377278 A1
(43) Pub. Date: Dec. 11, 2025

(54) METHOD AND SYSTEM FOR ASCERTAINING DENSITY OF HARVESTED MATERIAL

(71) Applicant: Deere & Company, Moline, IL (US)

(72) Inventors: Stefan Brocke, Mannheim (DE); Norbert Peter Fritz, Ilvesheim (DE)

(21) Appl. No.: 19/229,216

(22) Filed: Jun. 5, 2025

(30) Foreign Application Priority Data
Jun. 10, 2024 (EP) 24181059.7

(51) Int. Cl. G01N 9/24; G01S 13/88

(52) U.S. Cl. CPC G01N 9/24; G01S 13/88

(57) ABSTRACT

The present disclosure includes a method for ascertaining a density of a stored harvested material, the surface of which is driven over by a utility vehicle for compaction purposes, the method comprising: sending radar signals in a direction of the harvested material by a radar sensor; receiving radar signals reflected at the harvested material by the radar sensor; providing a density model on the basis of reference data; and ascertaining, via a control unit, the density on the basis of the density model provided and the reflected radar signals received. The system may include the control unit to ascertain the density of the stored harvested material.

### CROSS-REFERENCE TO RELATED APPLICATIONS

This application claims priority to European Patent Application No. 24181059.7, filed Jun. 10, 2024, which is hereby incorporated by reference.

### TECHNICAL FIELD

The present disclosure relates generally to ascertain the density of harvested material.

### BACKGROUND

Silage, which is produced from cuttings, such as grass, corn, clover, alfalfa, broad beans, or grains by fermentation (lactic acid fermentation) is often used for animal feed. A sensor that works with radar waves is used to measure the density of the silage.

### SUMMARY

According to an aspect of the present disclosure, a method for ascertaining a density of a stored harvested material, the surface of which is driven over by a utility vehicle for compaction purposes, the method comprising: sending radar signals in a direction of the harvested material by a radar sensor; receiving radar signals reflected at the harvested material by the radar sensor; providing a density model on the basis of reference data; and ascertaining, via a control unit, the density on the basis of the density model provided and the reflected radar signals received.

According to an aspect of the present disclosure, a system for ascertaining a density of a stored harvested material, comprising: a utility vehicle configured for compacting the stored harvested material; a radar sensor arranged on the utility vehicle and configured for sending radar signals in a direction of the harvested material and receiving radar signals reflected at the harvested material; and a control unit configured for ascertaining the density on the basis of a density model provided based on the reference data and the reflected radar signals received.

Other features and aspects will become apparent by consideration of the detailed description, claims, and accompanying drawings.

### BRIEF DESCRIPTION OF THE DRAWINGS

The disclosure is explained in greater detail below with reference to the appended drawings. Component parts of equivalent or comparable function are identified by the same reference signs in this case. In the drawings:

FIG. 1 shows an illustration in the manner of a block diagram of the system according to the disclosure, and

FIG. 2 shows an illustration in the manner of a block diagram of details of the method according to the disclosure, and

FIG. 3 shows a schematic illustration of the generation of reference data, and

FIG. 4a shows a schematic plan view of a utility vehicle and a harvested material to be compacted, and

FIG. 4b shows a side view of the utility vehicle and the harvested material to be compacted according to the arrow direction IV-B in FIG. 4a, and

FIG. 5 shows a schematic side view of a sensor device with a radar sensor, and

FIG. 6 shows an enlarged schematic view of the detail VI in FIG. 1, and

FIG. 7a shows a side view of a utility vehicle with the sensor device according to FIG. 6 in a working position, and

FIG. 7b shows the side view of the utility vehicle according to FIG. 7a with the sensor device in a transporting position.

Like reference numerals are used to indicate like elements throughout the several figures.

### DETAILED DESCRIPTION

DE 10 2020 110 297 A1 shows measuring the density of silage when the silage is compacted in a silo. For this, a sensor that works with radar waves is used, which can be mounted on the front of a compaction vehicle.

The object of the present disclosure is to further improve a radar-based ascertainment of a silage density.

This object is achieved by a method having the features of one or more embodiments disclosed herein and a system having the features of one or more embodiments disclosed herein.

Further advantageous embodiments of the disclosure can be found in one or more embodiments disclosed herein.

According to one or more embodiments disclosed herein, a method is proposed for ascertaining a density of a stored harvested material, the surface of which is driven over by a utility vehicle for compaction purposes. A radar sensor sends radar signals (e.g. by means of a transmitter antenna) in the direction of the harvested material. In addition, radar sensors receive (e.g. by means of a receiving antenna) the radar signals reflected at the harvested material. Based on reference data, a density model is provided. On the basis of the density model provided and the reflected radar signals received, the density of the harvested material is ascertained.

Preferably, the density model contains or represents a defined stochastic or mathematical relationship between different reference data, for example as one or more specific formulas, algorithms or the like. This relationship forms a defined basis for a accurately ascertaining the density depending on the reflected radar signals received during the compaction work.

The provision of the density model makes it possible to dispense with the extensive generation or acquisition of current data and parameters during the execution of the method, apart from the currently received reflected radar signals. As a result, the metrological outlay for ascertaining the density, in particular the technical equipment on the utility vehicle, can be kept to a minimum.

Using the density model provided and generated with the aid of reference data, a current density or compaction state of the stored harvested material can be ascertained in real time as the harvested material surface is driven over. The technical effort for this is extremely low, since in addition to the density model, only the currently received reflected radar signals are required. Knowledge of the current density or the current compaction state aids the efficient driving operation of the utility vehicle since the compaction activity may be terminated when a desired and precisely ascertainable density is achieved. In other words, the quality, in particular feed quality, of the stored and compacted harvested material may be improved, while the efficiency of the compaction task is simultaneously increased. As a result, high-quality animal feed may be produced with low operating costs. An awareness and monitoring of the continuously ascertainable current density of the stored harvested material relieves the pressure on a worker (e.g. vehicle driver) during the compaction task and helps him/her to make decisions for efficient compaction work. In particular, during the driving operation of the utility vehicle, the worker may decide in real time whether or not sufficient compaction has been achieved. Moreover, electronic processing of the current density ascertained in each case may aid at least partial automation of the compaction task.

The ascertained density may be represented, for example, by an absolute numerical value or by a percentage value. As percentage values, e.g. 0% may be used for a non-compacted state, 100% may be used for a fully compacted state and values between 0% and 100% may be used for a corresponding partially compacted state of the harvested material.

During the compaction work, the radar signals need to be transmitted in the direction of the harvested material essentially only once, preferably automatically or manually (e.g. via an operating interface, an actuating element, etc.). The further method steps for determining the density can be carried out automatically with little technical effort.

During the compaction work, the currently ascertained actual density can be compared with a target density (automatically or by a worker) while repeatedly carrying out the method, so that the actual density of the harvested material approaches the desired target density with optimized effort. This allows stable silage to be produced very efficiently.

The compaction of the stored harvested material (e.g. stored in a silo) is part of the manufacturing process for silage as animal feed. As harvested material, biomass from agricultural land is preferably used. In particular, different types of harvested material are conceivable, such as grass or the non-fruit content of maize, millet or other cereal crops.

The commercial vehicle used to compact the harvested material is, for example, a tractor. Preferably, the tires of the tractor can be used for compaction. Alternatively or additionally, a separate compaction device (e.g. compactor, silage roller) coupled to the tractor can be provided.

Preferably, the reflected radar signals and/or at least one physical quantity derived from them are processed with the density model. The processing can be performed mathematically and physically precisely in the context of signal processing in a control unit. Preferably, the reflected radar signals and/or variables derived from them are used during the processing as input variables for the density model, wherein the input variables or their values can be processed mathematically in the density model. Here, the density model may contain one or more suitable formulas or algorithms for calculating the density. This supports a convenient and accurate density determination. For example, an amplitude spectrum, the amplitude values of which are ascertained at predetermined characteristic frequencies, is calculated from the reflected radar signals. Defined amplitudes of the amplitude spectrum can thus be used as input variables for the density model. In the density model, for example, a formula for determining a model density may contain a sum of several subproducts c1·a1+c2·a2+c3·a3, wherein a1, a2, a3 are placeholders for the determined amplitude values and the coefficients c1, c2, c3 are derived from the reference data. The density of the harvested material to be determined can be derived from this model density as a processing result, in particular equated with this model density.

In a preferred embodiment, a current moisture content of the harvested material is ascertained depending on the received reflected radar signals and/or the density model provided. This means that specific sensors on the utility vehicle for determining moisture content can be dispensed with, thereby achieving cost savings.

Preferably, the reference data and/or the density model derived from the reference data are generated already before the start of compaction of the harvested material and the density model can then be conveniently provided as soon as the method for ascertaining density is to be carried out. The reference data are therefore generated as calibration data and the density model can be considered as a defined result of a calibration method. This supports a reduced physical/technical effort during the execution of the method itself. The density model and optionally also the reference data can be stored in particular in a database and thereby provided for the execution of the method. For example, the reference data can be generated in experimental tests. Specific devices, such as a test stand for testing (in particular for defined compaction) of reference material of a harvested material, an oven for drying reference material and/or a reference sensor for acquiring reference values of the reference material being examined can be used.

Advantageously, the reference data and/or the density model are generated and provided for different states of the same reference material, so that in the application as precise a determination of current density as possible is supported for different states of the harvested material.

The physical quantity or quantities for the reference data is/are preferably at least one of the following quantities with respect to the reference material of a selected harvested material: a reference density, a reference moisture content, or a reference cutting length.

Thus, for sampling or generating reference data, in particular such physical quantities are taken into account which are also of interest in the analysis of the harvested material during the execution of the method. The reference density can be ascertained as mass (e.g. dry mass fraction or total mass) per unit volume. The reference data regarding the reference density may also contain a characteristic curve representing a ratio between an expansion and contraction behavior of the reference material and a defined compaction force acting on it.

The reference moisture content (e.g. percentage) can be determined by means of a reference sensor or by means of a drying process (e.g. mass loss when completely dried in an oven). The reference cutting length can be determined by means of a suitable optical method.

The reference data further preferably contain reference radar information based on the reference radar signals reflected at the reference material. In other words, the reference radar information represents a reflection behavior of the reference material. The item of reference radar information rad_ref can here take various compaction states (from 0% to 100%) into account.

In particular, the reference data contain a suitable mathematical or stochastic relationship between the reference radar information and at least one of the above-mentioned quantities (reference density, reference moisture content, reference cutting length). This supports precise density determination when reflected radar waves currently received are processed with the density model derived from reference data during the execution of the method.

Further preferably, the reference data and/or the density model for different types of reference material, i.e., for different types of harvested material, are generated and provided. In this way, the appropriate reference data, and/or density model for the type of harvested material to be compacted can be conveniently selected or retrieved.

To ascertain the current density with even greater accuracy, at least one of the following items of information is preferably additionally taken into account: an item of calibration information, a moisture content of the harvested material, a cutting length or chop length of the harvested material, a type of the harvested material, or a starting information representing the start of the compaction.

By taking this at least one additional item of information into account, the radar-based density determination can be made even more precise. This at least one item of information can be provided at least partially by one or more suitable sensors, which are preferably arranged on the utility vehicle.

The calibration information contains, for example, a previously known characteristic curve (e.g., a relationship between the harvested material density and at least one other physical quantity) or calibration values for individual constants and parameters.

In terms of the type of harvested material, for example, a distinction can be made between mown grass, maize, and various cereal crops. The information may also represent a biological state of the harvested material (e.g., fresh or wilted).

The starting information representing the start of the compaction can be a start signal for the start of the method execution, i.e., for the start of the density determination. The starting information can be generated automatically (e.g., by sensors) or manually (e.g. by a driver of the utility vehicle). Alternatively or in addition, the starting information may contain a start time of the compaction activity, so that a current duration of the compaction activity can also be taken into account when ascertaining the density.

The above-mentioned at least one item of information is generated in particular during the compaction traversal by the commercial vehicle. Thus, current data support a precise determination of the density during the method execution.

The processing of data (e.g. in a control unit) to determine the density can take place during the compaction traversal or while the utility vehicle is at a standstill, in particular while it is kept at the storage location of the harvested material or in the silo. In both cases, the method efficiently contributes to providing accurate real-time data on the current density of the harvested material at the location where the harvested material is stored.

A density is advantageously ascertained in each case at multiple surface sections along the surface of the stored harvested material that is to be compacted. As a result, individual surface sections of the harvested material may be driven over more or less frequently than other surface sections in order to achieve uniform compaction along the surface of the harvested material in an efficient manner.

The ascertained density is preferably represented visually on a display unit. For example, the calculated density can be represented as a concrete numerical value (e.g. absolute density or percentage density of 0% to 100%). In the case of the above-mentioned section-related compaction states, a visual representation of the surface of the harvested material that is divided into surface sections is advantageous, with different section-related compaction states or different section-related densities being represented by different colours of the surface sections.

The display unit (e.g. screen) may be part of a user interface for inputting, displaying and outputting data or information. The display unit may be arranged within the utility vehicle or it may be, for example, part of a mobile or portable device outside the utility vehicle.

The disclosure further relates to a system for determining the density of a stored harvested material, having a utility vehicle for compacting the stored harvested material, a radar sensor arranged on the utility vehicle and having a control unit for carrying out the aforementioned method.

The system according to the disclosure has the above-described advantages of the method according to the disclosure. The control unit may contain suitable algorithms for ascertaining a current density or a current compaction state of the stored harvested material. The system enables data to be provided, which are oriented toward a precise setpoint density of the stored harvested material. This aids high-quality feed production (e.g. silage) along with efficient operation of the utility vehicle. The ability to continuously ascertain the current density of the harvested material by means of the method relieves the pressure on the vehicle driver and also other workers during the compaction task. Moreover, ascertained values of the density may serve as a realistic database for automation of an efficient work process during the compaction of the stored harvested material.

In relation to the ascertained current density, the control unit may generate various further data which may aid a worker via further information and/or which may aid the control of the utility vehicle during the compaction task. For example, any necessary remaining compaction or a setpoint compaction which depends on the harvested material (e.g. the type, biological state, moisture content) may be calculated via specific algorithms of the control unit. Depending on the ascertained current density, the utility vehicle may be controlled via the control unit in order to make the operation of said utility vehicle more efficient. In this regard, relevant vehicle parameters, for instance the tire pressure, the vehicle speed, the steering or the track of the vehicle, may be controlled via the control unit in a desired manner.

In particular, various types of agricultural utility vehicles (e.g. tractors, shovel loaders, telescopic loaders) are suitable utility vehicles. Autonomous vehicles without vehicle drivers or remote controlled vehicles are also conceivable.

In a preferred embodiment, the control unit is integrated in the utility vehicle. It may be connected, for example, to a system bus (e.g. ISO, CAN) and/or to other function units of the utility vehicle. The data exchange that is possible as a result may aid precise and efficient functionality of the system.

The system further preferably has at least one of the following components, which is connected to the control unit via a data connection:

A user interface for inputting and/or visually representing data. As a result, user-based data, in particular data coming from the vehicle driver, may be taken into account in a technically simple manner when ascertaining the density. Moreover, the current density and the progress of the compaction process may be represented visually, which relieves the pressure on the worker or the vehicle driver during the compaction task.

A position detection system (e.g. GPS receiver and, if applicable, further components), which is preferably arranged on the agricultural utility vehicle.

A data center containing data which are generated and/or provided while carrying out the method. As a result, the control unit may efficiently access data which are relevant for ascertaining the density and for monitoring the compaction progress.

A database containing a density model provided in relation to reference data for determining the density as a function of radar signals reflected at the harvested material. This aids the supply of data material to the control unit for precisely ascertaining the density of the stored harvested material. This database can be provided inside or outside the control unit.

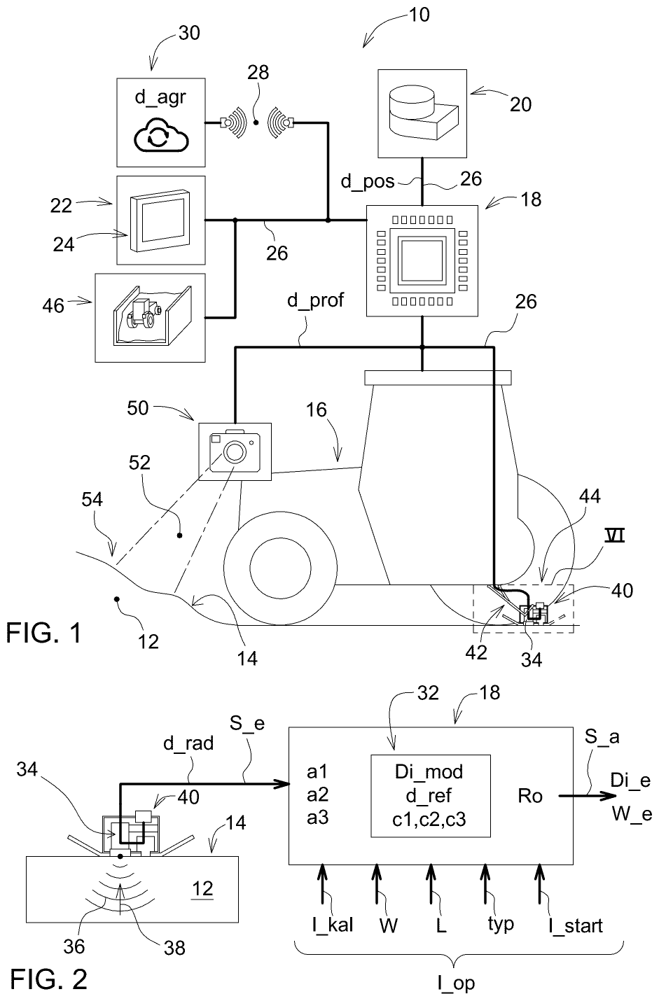

FIG. 1 shows a system 10 for ascertaining a density Di_e of a stored harvested material 12, the surface 14 of which is driven over by an agricultural utility vehicle 16, here in the form of a tractor, in order to compact it. The ascertained density Di_e is output by output signals S_a of a control unit 18. The output signals can optionally moreover include a moisture content W_e, ascertained by means of the control unit 18, of the harvested material 12 and further data of interest in relation to the compaction task.

The control unit 18 is preferably integrated in the utility vehicle 16. The utility vehicle 16 is controlled, for example, by a vehicle driver or is active in an automated manner as an autonomous vehicle.

The utility vehicle 16 and further components of the system 10 are connected to the control unit 18 via a suitable data connection in order to ascertain a current density Di_e and to communicate this to a worker (for example, the vehicle driver) in particular in a visual manner.

A position detection system 20 (e.g. GPS) and a user interface 22 (e.g. keyboard and display unit 24 for inputting and/or visually representing data) are arranged in or on the utility vehicle 16 and are each connected to the control unit 18 via a wired data connection 26. The control unit 18 is connected to a data center 30 via a wireless data connection 28. The data center may be based on Cloud technology. It may serve as a central data storage device and/or data processing center for various agriculture-related activities of a farmer or on a farm. The data center 30 includes, inter alia, various agriculture-related data d_agr. At least some of these data d_agr can be generated, and stored in the data center 30, for example, while carrying out the method for ascertaining the density Di_e and/or they can be provided by the data center 30 before, and therefore also while, carrying out the method. For example, the control unit 18 sends various output signals S_a, in particular the current density Di_e, to the display unit 24 for visually representing the density Di_e in real time and simultaneously transmits these output signals S_a to the data center 30 via the data connection 28.

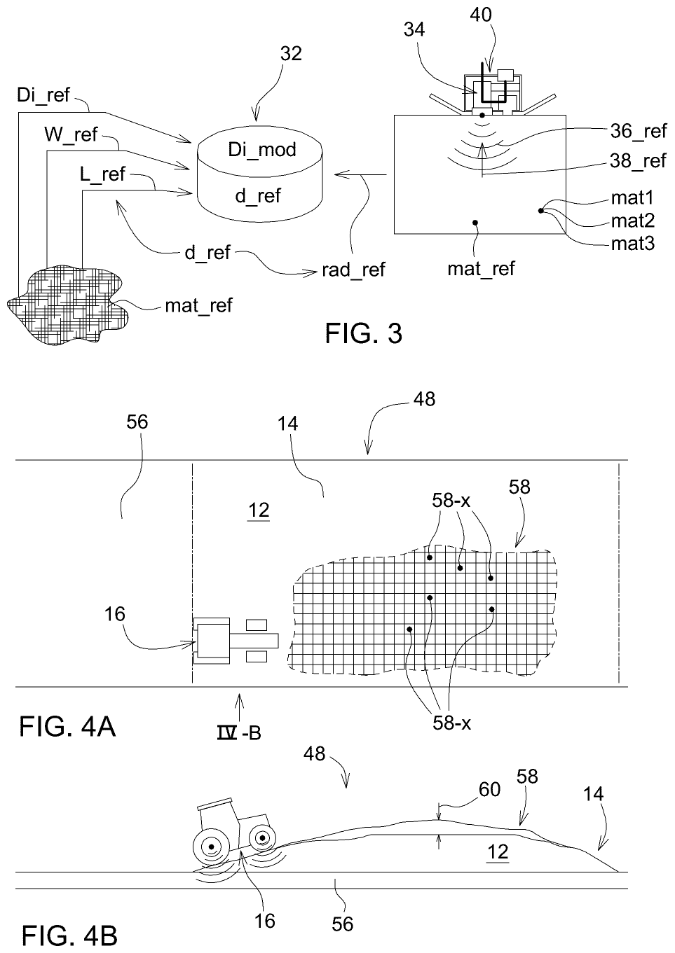

A database 32 with reference data d_ref and a density model Di_mod is included in the control unit 18 (FIG. 2). Alternatively, the reference data d_ref and/or the density model Di_mod or the database 32 can be present outside the control unit 18, in particular in the data center 30, such that the control unit 18 can at all times access the reference data d_ref and/or the density model Di_mod via the data connection 26 or 28. The reference data d_ref and the density model Di_mod are explained in more detail with reference to FIG. 3.

The control unit 18 ascertains a current density Di_e of the harvested material 12 by the use of radar technology. For this purpose, a radar sensor 34 which sends radar signals 36 in the direction of the harvested material 12 and receives radar signals 38 reflected on the harvested material 12 during the compacting task is arranged on the utility vehicle 16. The radar sensor 34 is a constituent part of a sensor device 40 which is arranged on a support device 42. The support device 42 is in turn movably mounted on the utility vehicle 16. The sensor device 40 and the support device 42 can be referred to jointly as a sensor module 44 which is explained in greater detail with reference to FIG. 6 to FIG. 7b.

The control unit 18 can access environmental data 46 of the storage location of the harvested material 12 in particular via the data connection 26. The storage location is in particular a silo 48 (FIG. 4a). The environmental data 46 are preferably generated by means of a suitable sensor system and saved in a database. They represent in particular current environmental conditions and features of the utility vehicle 16 in real time. With the aid of the environmental data 46, the control unit 18 can control the method for ascertaining the density, in particular automatically start the method for ascertaining the density, when the utility vehicle 16 has reached a corresponding position at the storage location.

Furthermore, an environment sensor 50, which generates profile data d_prof within a field of vision 52 on the basis of a detected surface profile 54 of the harvested material 12, can be arranged on the utility vehicle 16. The environment sensor 50 preferably also assists generation of the environmental data 46. The control unit 18 can activate the support device 42 depending on the profile data d_prof, as explained in greater detail with reference to FIG. 7a and FIG. 7b.

FIG. 2 shows the control unit 18 which receives, inter alia, radar data d_rad as input signals S_e. The radar data d_rad represent at least the radar signals 38 reflected on the harvested material 12 and possibly also further information. The reflected radar signals 38 can be processed with the supplied density model Di_mod on the basis of the radar data d_rad. Depending on the processing result, the current density Di_e can be ascertained or derived. The moisture content W_e of the harvested material 12 can optionally also be ascertained.

The density Di_e can be ascertained permanently currently or in real time by the control unit 18 when the utility vehicle 16 drives over the harvested material 12 to compact it. The control unit 18 can, however, also ascertain a current density Di_e whilst the utility vehicle 16 is stationary, in particular when it is stopped on the storage location or in the silo 48.

The control unit 18 can receive further information I_op or quantities at least one additional signal input. These are, for example: an item of calibration information I_kal (for example, physical constants or material parameters with respect to the harvested material 12), a moisture content W of the harvested material 12, a cutting length L of the harvested material 12, a type typ of the harvested material 12 (for example, the type of crop, state of vegetation of the crop), or an item of information I_start representing the start of the compaction (for example, a start signal for ascertaining the density Di_e, a start time for ascertaining the density, a signal derived from the environmental data 46).

The above-mentioned information I_op or quantities can be retrieved from other data sources or they can be input manually via the user interface 22 or they can be provided by measurements (for example, by means of a sensor). Even more accurate ascertainment of the density Di_e can be assisted with this additional information I_op. The control unit 18 does not necessarily have to be provided with all of the above-mentioned information or quantities. For example, the moisture content W and the item of information typ characterizing the harvested material 12 are information which is only optionally received by the control unit 18 in each case. Furthermore, other information or quantities not mentioned here may be optionally received by the control unit 18.

At least some of the information I_op is preferably generated when the utility vehicle 16 is driving over the harvested material to compact it, i.e. during the compacting work.

In a further function, the control unit 18 can be used to control the utility vehicle 16 depending on the ascertained current density Di_e in order to assist the operation of said utility vehicle. In this regard, relevant vehicle parameters, for instance the tire pressure, the vehicle speed or the steering, may be controlled via the control unit 18. Likewise, the control unit 18 can calculate a required remaining compaction depending on the ascertained current density Di_e. A material-specific target density (for example, depending on the type and moisture of the harvested material) can also be ascertained by the control unit 18.

FIG. 3 shows by way of example generation of reference data d_ref before the compacting of the harvested material 12 starts in the particular use case. In experimental trials for a reference material mat_ref of the harvested material 12, an item of reference radar information rad_ref is, for example, here detected on the basis of reflected reference radar signals 38_ref in the case of a defined reference density Di_ref, a defined reference moisture content W_ref, and a defined reference cutting length L_ref. The item of reference radar information rad_ref represents reflection behavior of the reference material mat_ref and possibly also further physical features. The item of reference radar information rad_ref can here take various compaction states (from 0% to 100%) into account.

When generating the reference data d_ref, a sensor device 40 is preferably used which is identical, at least in terms of the radar sensor 34, to the radar sensor 34 used when the utility vehicle 16 is driven over the harvested material to compact it. Emitted reference radar signals 36_ref here generate reflected reference signals 38_ref in the reference material mat_ref.

The reference data d_ref are preferably generated with respect to the same reference material for different states in terms of the reference density Di_ref and/or the reference moisture content W_ref and/or the reference cutting length L_ref. The reference data can also be generated for different reference materials mat_ref, in particular materials of different types of harvested material 12. Different reference materials are indicated by way of example in FIG. 3 by the materials mat1, mat2, mat3.

The data with respect to the reference density Di_ref can also include data which represent an expansion characteristic (in particular material behavior in the non-compacted state and after a defined compaction).

Depending on the reference data d_ref or at least some of this data, a density model Di_mod is derived or generated and can then be supplied for the method for ascertaining the density Di_e. The reference data d_ref are generated as calibration data and the density model can be considered as a defined result of a calibration method. In particular, the density model Di_mod includes or represents a mathematical or stochastic relationship between the item or items of radar information rad_ref and at least one of the above-mentioned quantities (reference density Di_ref, reference moisture content W_ref, reference cutting length L_ref). This relationship is such that accurate mathematical processing of the radar data d_rad with the density model Di_mod is assisted during the processing work in the particular use case.

For example, the density model Di_mod includes an algorithm or a formula according to which a model density Ro is defined as

Ro=c1·a1+c2·a2+c3·a3

·a1, a2, a3 are here place holders for amplitude values of the reflected radar signals 38 and c1, c2, c3 are derived from the reference data d_ref as coefficients. An amplitude spectrum, the amplitude values a1, a2, a3 of which are ascertained at predetermined characteristic frequencies, is calculated from the reflected radar signals 38. Defined amplitudes of the amplitude spectrum can thus be used as input variables for the density model Di_mod. In the example, the density Di_e to be ascertained is derived from the model density Ro, in particular is made to equal the model density Ro.

FIG. 4a and FIG. 4b show the silo 48 on the floor 56 of which the harvested material 12 is stored. Material 60 of the harvested material 12 is to be compacted in a surface region 58. With the aid of position data d_pos of the utility vehicle 16, the surface region 58 can be divided into multiple surface sections 58-x for which a density Di_e is ascertained in each case. The position-dependent density Di_e can then be sent to the user interface 22 by means of the control unit 18. The surface 14 to be driven over, in particular the surface region 58, can in this way be represented visually on the display unit 24 in real time, with current densities Di_e assigned section by section. Different densities Di_e can here be represented by different colors. For example, non-compacted surfaces sections 58-c may be represented by a red color, fully compacted surface sections 58-x may be represented by a green color and surface sections 58-x having other compaction states or levels may be represented by corresponding color gradations.

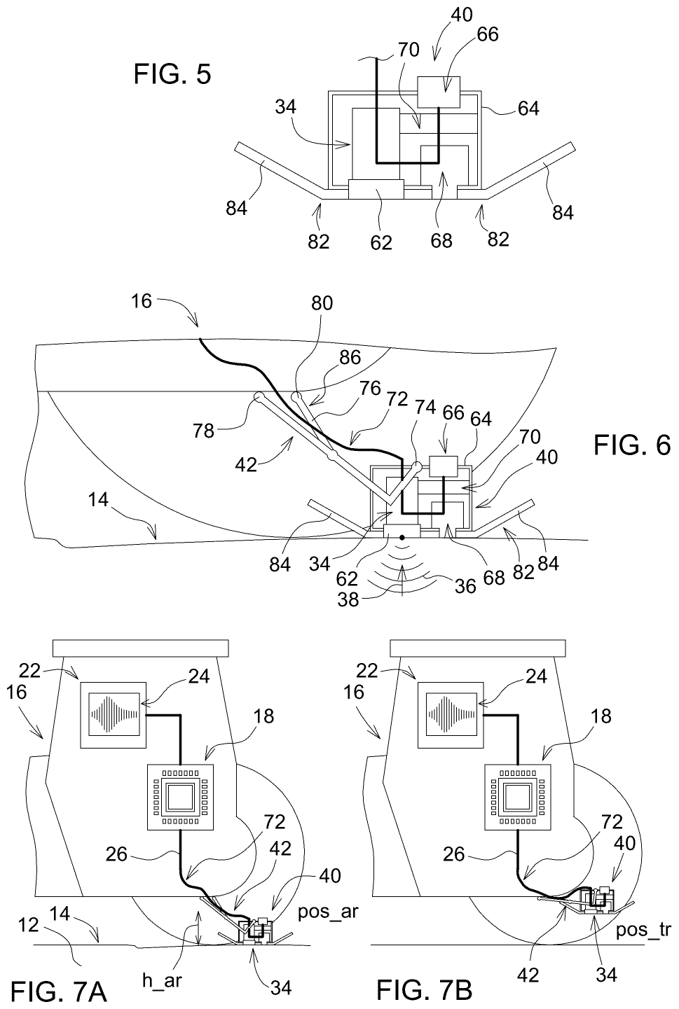

FIG. 5 shows the sensor device 40 with multiple components. The already mentioned radar sensor 34 is designed here as a radar antenna with a send and receive function. For efficient emitting of the radar signals 36 in the direction of the harvested material 12, the radar sensor 34 has a signal outlet 62 which traverses a sensor housing 64. Apart from the radar sensor 34, the sensor device 40 optionally includes a sensor unit 66 for controlling the temperature of the sensor device 40, and a further sensor system 68, for example for measuring the temperature or for optical detection in the region of the harvested material 12. An electronics system 70 for the radar sensor 34 and the optional sensors 66, 68 is moreover included in the sensor housing 64.

As can be seen in FIG. 6, the electronics system 70 is connected to a cable harness 72 for supplying energy to the sensor device 40 and for data transmission. The cable harness 72 preferably includes a supply cable for supplying energy to the sensor device 40 and a data cable for the data transmission. At least the data cable of the cable harness 72 is connected to the sensor device 40 and the control unit 18. Thus, for example, the reflected radar signals 38 can be sent to the control unit 18 in the form of radar data d_rad by means of the cable harness 72.

The sensor housing 64 is mounted movably on the support device 42, in particular is mounted on the support device 42 by means of a pivot axis 74 running transversely to the longitudinal direction of the utility vehicle 16. The support device 42 is designed as a multi-arm lever construction, the movement of which can be controlled by means of an actuator 76 in the form of a length-adjustable lever arm, for example a hydraulic cylinder. As a result, the actuator 76 effects the setting of different positions of the sensor device 40 relative to the surface 14 of the harvested material 12. Both the actuator 76 and the support device 42 are movably mounted on the utility vehicle 16 via the mounting points 78, 80.

The support device 42 is connected to a contact unit 82 for mechanical sliding contact with the surface 14 of the harvested material 12. The contact unit 82 is here fastened on a bottom side of the sensor housing 64 and assists the sensor device 40 or the radar sensor 34 in its functionality even in the case of an unfavorable profile of the surface 14 of the harvested material 12. The contact unit 82 has in each case one runner 84 at both longitudinal ends such that the function of the contact unit 82 is performed when the utility vehicle 10 is driving both forward and in reverse.

The positions of the support device 42 which can be set are in particular a working position pos_ar for the radar sensor 34 (FIG. 7a) and a transporting position pos_tr for the radar sensor 34 which is elevated compared with the working position pos_ar (FIG. 7b). The transporting position pos_tr is advantageously set when no ascertainment of the density is taking place, in particular when the utility vehicle 16 is situated outside the silo 48. The working position pos_ar which is lowered compared thereto is advantageously set when the utility vehicle 16 is driven into the silo 48 and in particular when it is standing on the harvested material 12. In order to set the two positions pos_tr, pos_ar, the support device 42 and/or the actuator 76 is activated by the control unit 18 depending on the environmental data 46.

The working position pos_ar can be set differently in terms of its vertical working height h_ar. As a result, direct contact (distance=0) or a constant distance >0 can, for example, be produced between the sensor device 40 or the contact unit 82 and the surface 14. For this purpose, the support device 42 and/or the actuator 76 is activated by the control unit 18 depending on the profile data d_prof. Alternatively, the support device 42 and/or the actuator 76 can be placed in a floating mode such that the sensor device 40 or the contact unit 82 slides along the surface 14 in a free-floating fashion. The dead weight of different components, in particular of the sensor device 40, can hereby advantageously be absorbed in such a way that these components do not become buried in already compacted material of the harvested material 12. This material thus remains reliably compacted. For this weight force strain relief, a strain relief device 86 mounted on the utility vehicle 16 is provided which includes, for example, the actuator 76. Alternatively or additionally, the strain relief device 86 can include other components (not illustrated here) for the force strain relief such as, for example, at least one spring element (in particular tension spring) and at least one chain. These components are preferably coupled to one another, mounted on one side on the utility vehicle 16 and connected to the sensor device 40 on the other side.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A method for ascertaining a density of a stored harvested material, the surface of which is driven over by a utility vehicle for compaction purposes, the method comprising:
sending radar signals in a direction of the harvested material by a radar sensor;
receiving radar signals reflected at the harvested material by the radar sensor;
providing a density model on the basis of reference data; and
ascertaining, via a control unit, the density on the basis of the density model provided and the reflected radar signals received.

2. The method of claim 1, wherein the reflected radar signals or a quantity derived therefrom are processed with the density model, and the density is ascertained on the basis of the processing result.

3. The method of claim 1, wherein on the basis of the density model provided or on the reflected radar signals received, a moisture content of the harvested material is ascertained.

4. The method of claim 1, wherein the reference data or the density model are generated before the start of compaction of the harvested material.

5. The method of claim 1, wherein the reference data includes at least one of the following quantities of a reference material of the harvested material: a reference density, a reference moisture content, or a reference cutting length.

6. The method of claim 1, wherein the reference data includes a reference radar information item, which represents reference radar signals reflected at the reference material of the harvested material.

7. The method of claim 1, wherein reference data or the density model are provided for different reference materials of the harvested material.

8. The method of claim 1, wherein the density is ascertained according to at least one of the following items of information: an item of calibration information, a moisture content of the harvested material, a cutting length of the harvested material, a type of the harvested material, and an item of start information representing the start of compaction.

9. The method of claim 8, wherein the at least one item of information is generated during the compaction traversal by the commercial vehicle.

10. The method of claim 1, wherein the density is ascertained during the compaction traversal or while the utility vehicle is at a standstill.

11. The method of claim 1, wherein a density is ascertained in each case in multiple surface sections along the surface of the stored harvested material that is driven over.

12. The method of claim 1, wherein the ascertained density is represented visually on a display unit.

13. A system for ascertaining a density of a stored harvested material, comprising:
a utility vehicle configured for compacting the stored harvested material;
a radar sensor arranged on the utility vehicle and configured for sending radar signals in a direction of the harvested material and receiving radar signals reflected at the harvested material; and
a control unit configured for ascertaining the density on the basis of a density model provided based on the reference data and the reflected radar signals received.

14. The system of claim 13, wherein the control unit is included in the utility vehicle.

15. The system of claim 13, wherein at least one of the following components is part of the system and is connected to the control unit via a data connection: a user interface for inputting or visually representing data, a position detection system, a data center including data which are generated or provided while carrying out the method, or a database having the density model provided on the basis of reference data for ascertaining the density as a function of the radar signals reflected at the harvested material.

16. The system of claim 13, wherein the reflected radar signals or a quantity derived therefrom are processed with the density model, and the density is ascertained on the basis of the processing result.

17. The system of claim 13, wherein on the basis of the density model provided or on the reflected radar signals received, a moisture content of the harvested material is ascertained.

18. The system of claim 13, wherein, the reference data or the density model are generated before the start of compaction of the harvested material.

19. The system of claim 13, wherein the reference data includes at least one of the following quantities of a reference material of the harvested material: a reference density, a reference moisture content, or a reference cutting length.

20. The system of claim 13, wherein the density is ascertained according to at least one of the following items of information: an item of calibration information, a moisture content of the harvested material, a cutting length of the harvested material, a type of the harvested material, and an item of start information representing the start of compaction.
